(19) United States
(12) Patent Application Publication
(10) Pub. No.: US 2023/0228526 A1
(43) Pub. Date: Jul. 20, 2023

(54) DIGITAL HUNTING WEAPON SIGHT

(71) Applicant: Amigen, LLC, Santa Barbara, CA (US)

(72) Inventors: Jeffrey Heath Lee, Goleta, CA (US); Derek Moran, Santa Barbara, CA (US)

(21) Appl. No.: 18/095,481

(22) Filed: Jan. 10, 2023

Related U.S. Application Data
(60) Provisional application No. 63/299,676, filed on Jan. 14, 2022.

(51) Int. Cl. F41G 3/16; G01J 5/10; F41G 1/32

(52) U.S. Cl. CPC F41G 3/165; G01J 5/10; F41G 1/32

(57) ABSTRACT

A focus ring, similar in user feel to an optical scope focus ring, for an image sensor based weapon sight, wherein the ring is rotatable in a plane perpendicular to the weapon bore. The rotational position of the ring is sensed electronically and read by a weapon sight control processor, and the rotational position is used by the processor to set the digital zoom of a user accessible weapon sight electronic display. The weapon sight may be built in sections, including a stiff chassis section for the electronics and processor elements which includes the mounting to the weapon. The camera section which may include a combination of visible and/or thermal cameras, mounts to chassis and the chassis is enclosed by a floating housing that is compliantly mounted to the stiff chassis. The focus ring/rotational position sensor section mounts to the housing, thereby isolating the hard mounted weapon sight sections from parts of the sight handled by the user.

### BACKGROUND

This disclosure relates to a digital camera based Weapon Sight for hunting and in particular to a weapon sight that is accessible to users with primarily optical telescopic sight experience.

Application of digital camera technology, including visible, low light visible, and thermal cameras to hunting applications, may meet resistance from users with primarily optical scope experience. In particular, the use interface for digital weapon sights may be unfamiliar to users of traditional magnified glass optics. Traditional magnified glass optical sights have a specific placement of functional knobs and rings as actuators that have not been replicated well in digital systems. of traditional magnified glass optics. Example embodiments described herein have innovative features, no single one of which is indispensable or solely responsible for their desirable attributes. Without limiting the scope of the claims, some of the advantageous features will now be summarized.

### SUMMARY

A focus ring, similar in user feel to an optical scope focus ring, may be provided for an image sensor based weapon sight, wherein the ring is rotatable in a plane perpendicular to the weapon bore. The rotational position of the ring is sensed electronically and read by a weapon sight control processor, and the rotational position is used by the processor to set the digital zoom of a user accessible weapon sight electronic display. The weapon sight may be built in sections, including a stiff chassis section for the electronics and processor elements which includes the mounting to the weapon. The camera section which may include a combination of visible and/or thermal cameras, mounts to chassis and the chassis is enclosed by a floating housing that is compliantly mounted to the stiff chassis. The focus ring/rotational position sensor section mounts to the housing, thereby isolating the hard mounted weapon sight sections from parts of the sight handled by the user.

A weapon sight may be provided, including a body including one or more sections; at least one imaging sensor configured to provide image or video data; at least one processor configured to acquire and process the image or video data from the imaging sensor for display; at least one electronic display interfaced to the processor; at least one ring disposed in a section of the body, disposed to rotate in a plane perpendicular to a bore of the weapon when the sight is installed on the weapon, wherein the rotating ring is accessible to be rotated by a user of the weapons sight; at least one rotation stop disposed to provide a fixed rotational position for the ring; at least one electronic position sensor interfaced to the processor disposed to provide a signal indicative of the rotational position of the ring relative to the fixed rotational position, wherein, the digital magnification of the displayed image of the image or video data is determined by the processor based on the rotational position of the rotatable ring.

In one embodiment, the ring may include a feature, including a lever, or a raised area, extending out of the rotatable ring, serving to assist the user to actuate the rotating of the ring. In another embodiment, the electronics position sensor may be one of a series of magnetic sensors arranged on the ring and the body; or, a circular encoder disposed adjacent the ring and the body or &linear position sensor whose piston is tied to a cam driven by the zoom ring. In one embodiment, the body may include a section comprising a unitary chassis made of a stiff material, including metal plates, carbon fiber sections or hard plastics sections, wherein the unitary chassis may be configured to carry electronics and processor components and may include a mounting section for mounting the sight to the a weapon built as an integral part of the chassis, and wherein a housing may be disposed to cover at least a portion of the chassis and may be attached to the chassis with compliant mounting, including at least one of press fit mounting or isolation mounts. at least one imaging sensor configured to provide image or video data; at least one processor configured to acquire and process the image or video data from the imaging sensor for display; at least one electronic display interfaced to the processor; at least one ring disposed in a section of the body, disposed to rotate in a plane perpendicular to a bore of the weapon when the sight is installed on the weapon, wherein the rotating ring is accessible to be rotated by a user of the weapons sight; at least one rotation stop disposed to provide a fixed rotational position for the ring; at least one electronic position sensor interfaced to the processor disposed to provide a signal indicative of the rotational position of the ring relative to the fixed rotational position, wherein, the digital magnification of the displayed image of the image or video data is determined by the processor based on the rotational position of the rotatable ring.

In another embodiment, the weapon sight may further include a camera section, including at least one of a visible or a thermal camera core, and wherein the camera section may mount directly to the unitary chassis and when mounted electrically interfaces the cameras to the chassis electronics and processor components. In one embodiment, the rotatable ring and position sensor may be disposed in a body section that mounts directly to the housing and when mounted electrically interfaces the position sensor to the chassis electronics and processor components. In another embodiment, the housing may be configured to conform to the camera and position sensor/rotatable ring sections.

### BRIEF DESCRIPTION OF THE DRAWINGS

Aspects and advantages of the embodiments provided herein are described with reference to the following detailed description in conjunction with the accompanying drawings. Throughout the drawings, reference numbers may be re-used to indicate correspondence between referenced elements. The drawings are provided to illustrate example embodiments described herein and are not intended to limit the scope of the disclosure.

FIG. 1 shows an overall view of an illustrative embodiment of digital hunting weapon sight;

FIG. 2 internal details of an illustrative embodiment of digital hunting weapon sight;

FIG. 3 shows details of an illustrative embodiment of a stiff electronics chassis;

FIGS. 4A and 4B show details of an illustrative embodiment of a rotational position section;

### DETAILED DESCRIPTION

The current disclosure is directed toward addressing barriers to the adoption of digital weapons sights, i.e. weapon sights based on camera and electronic display architectures, by the hunting community. It should be noted however that the improvements disclosed herein apply equally well to military or law enforcement applications, but it is the hunting community where transition from optical to camera-based weapons sights is slowest.

The current disclosure addresses both user interface and basic construction areas and specifically aims to make the operational feel of digital sighs more comfortable for users as well as improve the manufacturability and lower the cost of digital scopes.

Digital Hunting scopes or weapons sights have many advantages over traditional optical scopes, not the least of which is the capability of low light or thermal imaging that can be incorporated in a digital camera based approach. Digital weapons sights may incorporate one or more digital cameras, interfaced to a processor, which acquired image data from the camera sensors, performs image processing as appropriate and causes image to be displayed to a user on an electronic display. Although a digital weapon sight may incorporate less elaborate and lower fidelity/resolution optics compared to a traditional telescopic sight, through digital image enhancement and zoom, the image presented to the user may be of equal or even better quality. Adding in that incorporating cameras of different types and spectral response, including thermal sensors, it is possible to produce a more versatile high performance unit with simple optics and structure.

However despite their appeal, there is resistance to adoption from traditional hunters. Digital weapon sights may be too complicated for users of traditional scopes to just start using. One specific complication is the digital zoom control feature. While digital zoom is not new, it is usually adjusted through a menu and some sort of button or knob control. Since this is the most used adjustment on scopes, some company product designers have added direct buttons or knobs to allow users to adjust the zoom directly. With button or rotating knob as often found in digital scopes, a queue on the screen to indicate digital zoom level, which may be text or another icon based indicator, may obscure the scene.

Another potential issue with digital scopes compared to optics is that optical scopes are relatively easy to manufacture, they consist of heavy glass and strong housing construction with very simple and rugged adjustment capability, usually just a few large threaded screw arrangements for moving focus and magnification optics or changing aiming point. Such construction is well suited and long established for the high shock conditions produced by weapons fire. By comparison, digital scopes entail the mechanical integration and electrical interconnection of multiple small and potentially fragile element, such as camera cores, miniature displays, printed circuit board and small format connectors, all of which have to be relatively small and densely packed to fit into the envelope available for a weapons sight. These digital scopes usually feature button or knob control arrangements which may be more expensive and difficult to manufacture. Since this is the most used adjustment on scopes, some company product designers have added direct buttons or knobs to allow users to adjust the zoom directly. But almost all optical scopes use a zoom ring control to physically move the elements of glass magnified optics. This approach has feel that is both traditional and very well suited to one handed scope control in field conditions, and it has the important feature that the optical zoom is completely fixed by and maintained at the optical position set by the zoom ring position. Furthermore, this approach has the direct effect of allowing the user to “feel” what digital zoom they are in by the position the zoom ring is in.

An exemplary embodiment of a digital weapons sight with design features that address the above and other issues is shown in the Figures and described below. It is to be understood that the detailed design features could also be implemented in a weapon sight design differing in details from the design shown, but still falling within the scope and spirit of current disclosure.

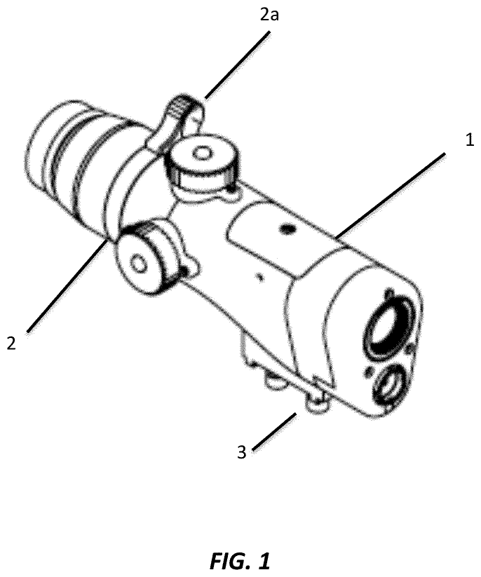

FIG. 1 shows an overall view of a digital weapons sight 1. In particular chassis 3, whose details will be described below includes the mounting provision to the weapons. Zoom ring 2 is shown located between the rear mount and the eyepiece focus, where it is quickly accessible by either the right or left hand and as close to the user as possible, as is the case for many traditional glass variable magnification hunting scopes. Other arrangements are possible but the arrangement as shown will appeal to traditional hunters. Lever 2a as shown is also in the same vein as it will be familiar to traditionalists, and is used to aid the user in rotating ring 2. This feature is not necessary, but it is useful to have a feature, such as a raised bump or protrusion, that extends out from the ring to some extent both to make the position of the ring clear and to aid in rotation. Wherever the exact position of the ring is on the weapon sight, it is desirable that the rotation be in a plane perpendicular to the weapon bore, and the apparent bore of the sight (which for a digital sight may not actually be internally varied. Such rotational positioning will appeal to traditional hunters.

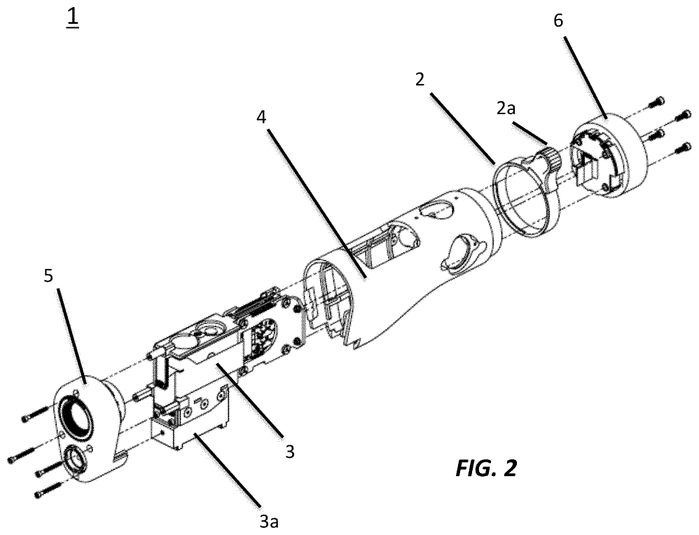

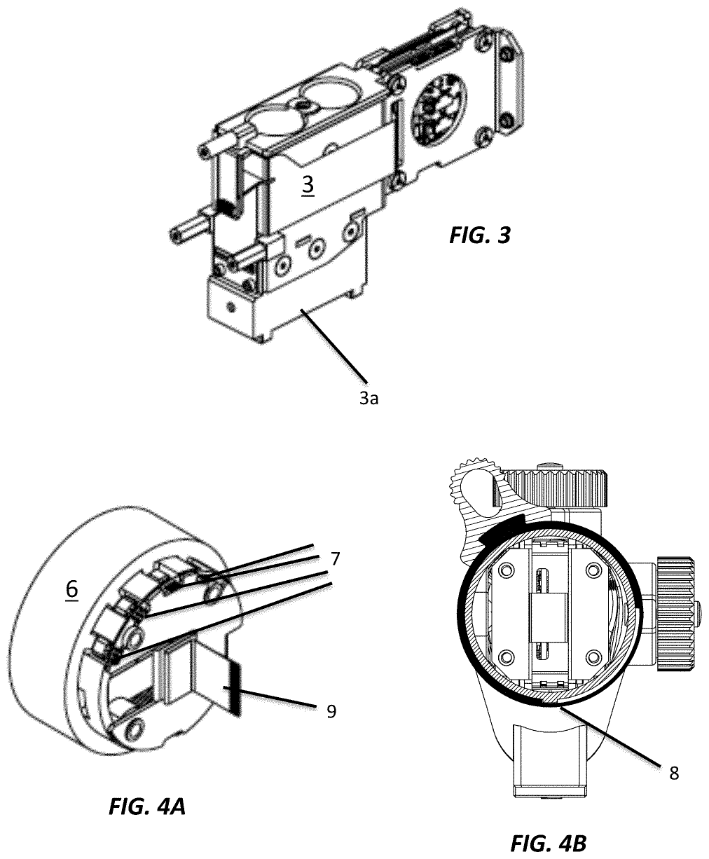

Referring to FIGS. 2, 3 and 4A and 4B internal details of the illustrative weapon sight embodiment are shown. As can be seen, the weapons sight 1 is made from sections as will be discussed. Zoom ring assembly 2 is located between the rear mount and the eyepiece focus, where it is quickly accessible by either the right or left hand and as close to the user as possible, as is the case for many traditional glass variable magnification hunting scopes. Other arrangements are possible but the arrangement as shown will appeal to traditional hunters. Lever 2a as shown is also in the same vein as it will be familiar to traditionalists, and is used to aid the user in rotating ring 2. This feature is not necessary, but it is useful to have a feature, such as a raised bump or protrusion, that extends out from the ring to some extent bot to make the position of the ring velar and to aid in rotation. Wherever the exact position of the ring is on the weapon sight, it is desirable that the rotation be in a plane perpendicular to the weapon bore, and the apparent bore of the sight (which for a digital sight may not actually be internally varies. Such rotational positioning will appeal to traditional hunters.

Focus Ring 2, with optional feature 2a rotate in position sensor section 6. Magnets and hall effect sensor 7 detect the rotational position of the zoom lever or ring without requiring a hole in an outer housing, eliminating a possible water intrusion spot. An encoder could be used, but then it would require a break in the housing to get the same measurement. There are stops at both ends 8 so the user knows when he/she is at both extents of the zoom range.

On power up, the magnification can set to the absolute position of the zoom ring. This is analogous to optical zoom scopes. To make the digital zoom function more accessible to traditional users other digital zoom features could be implemented and displayed by the processor. There could be an on screen display of the current zoom level which may disappear after a set timeout to not interfer with the user's video. This indicator could appear whenever there is a change in zoom setting or when other status indicators are available. Certain users may choose to set the zoom level display to “always on” so as to never be in question what zoom level they are in. Certain users may choose to have the zoom level display set to “always off” and simply rely on the mechanical position as the indicator. The digital system allows these types of software settings to be common to every system for production but tailored to the individual by the individual at the same time.

The construction of the illustrative sight is such that the housing 4 is essetially floating around a stiff chassis section 3 which supports the imaging sensors, display, and processor/electronic components to the mount 3a. Stiff chassis may be of a box like shape as shown or another rigid arrangement and made of stiff materials, including metals, carbon fiber, or other plastic and/or reinforced composite materials. This frame and mount are suitable to the high shock environment

In the embodiment, the sensor section 5, which in the embodiment shown has two camera sensors, which may be among other combinations a visible and a thermal camera. Obviously differing numbers and types of cameras are possible. The camera section can be mechanically and electrically directly attached to the chassis section 3. In the illustrative embodiment, a housing 4 covers the chassis section, but is not attached in a rigid mechanical fashion to the chassis or chassis mount 3a. The housing 4 may be press fit to the chassis, or attached by way of compliant mounts such as screws through elastomer standoffs, or other “floating” arrangements. In the embodiment shown, rotation sensor section 6 is attached to the housing 4, not the chassis 3, with a compliantly mounted connector 9 to the chassis electronic components. Thus, the zoom ring is designed such that it can float with the housing as it has no alignment requirements in contrast to the cameras and display, and can be very light in some cases simply a plastic ring and some small magnets, providing little shock load. Thus most areas of the sight 1 that will be handled by a user are floating relative to the mount. Such a design is well suited to the high shock environment.

The embodiments described herein are exemplary. Modifications, rearrangements, substitute material, alternative elements, etc. may be made to these embodiments and still be encompassed within the teachings set forth herein, which may be among other combinations may include both a visible and a thermal camera.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” “involving,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list., alternative elements, etc. may be made to these embodiments and still be encompassed within the teachings set forth herein.

Disjunctive language such as the phrase “at least one of X, Y or Z,” unless specifically stated otherwise, is otherwise understood with the context as used in general to present that an item, term, etc., may be either X, Y or Z, or any combination thereof (e.g., X, Y and/or Z). Thus, such disjunctive language is not generally intended to, and should not, imply that certain embodiments require at least one of X, at least one of Y or at least one of Z to each be present inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The terms “about” or “approximate” and the like are synonymous and are used to indicate that the value modified by the term has an understood range associated with it, where the range can be ±20%, ±15%, ±10%, ±5%, or ±1%. The term “substantially” is used to indicate that a result (e.g., measurement value) is close to a targeted value, where close can mean, for example, the result is within 80% of the value, within 90% of the value, within 95% of the value, or within 99% of the value.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

While the above detailed description has shown, described, and pointed out novel features as applied to illustrative embodiments, it will be understood that various omissions, substitutions, and changes in the form and details of the devices and components illustrated can be made without departing from the spirit of the disclosure. As will be recognized, certain embodiments described herein can be embodied within a form that does not provide all of the features and benefits set forth herein, as some features can be used or practiced separately from others. All changes which come within the meaning and range of equivalency of the claims are to be embraced within their scope.

1. A weapon sight, comprising:
A body comprising one or more sections;
At least one imaging sensor configured to provide image or video data;
At least one processor configured to acquire and process the image or video data from the imaging sensor for display;
At least one electronic display interfaced to the processor;
At least one ring disposed in a section of the body, disposed to rotate in a plane perpendicular to a bore of the weapon when the sight is installed on the weapon, wherein the rotating ring is accessible to be rotated by a user of the weapons sight;
At least one rotation stop disposed to provide a fixed rotational position for the ring;
At least one electronic position sensor interfaced to the processor disposed to provide a signal indicative of the rotational position of the ring relative to the fixed rotational position, wherein,
The digital magnification of the displayed image of the image or video data is determined by the processor based on the rotational position of the rotatable ring.

2. The weapon sight of claim 1 wherein the ring comprises a feature, including a lever, or a raised area, extending out of the rotatable ring, serving to assist the user to actuate the rotating of the ring.

3. The weapon sight of claim 1 wherein the electronics position sensor is one of;
comprised of a series of magnetic sensors arranged on the ring and the body; or,
a circular encoder disposed adjacent the ring and the body; or,
a linear position sensor whose piston is tied to a cam driven by the zoom ring

4. The weapon sight of claim 1 wherein the body includes a section comprising a unitary chassis made of a stiff material, including metal plates, carbon fiber sections or hard plastics sections, wherein the unitary chassis is configured to carry electronics and processor components and includes a mounting section for mounting the sight to the a weapon built as an integral part of the chassis, and wherein a housing is disposed to cover at least a portion of the chassis and is attached to the chassis with compliant mounting, including at least one of press fit mounting and isolation mounts.

5. The weapon sight of claim 4 comprising a camera section, comprising at least one of a visible or a thermal camera core, and wherein the camera section mounts directly to the unitary chassis and when mounted electrically interfaces the cameras to the chassis electronics and processor components.

6. The weapon sight of claim 5 wherein the rotatable ring and position sensor are disposed in a body section that mounts directly to the housing and when mounted electrically interfaces the position sensor to the chassis electronics and processor components.

7. The weapon sight of claim 6 wherein the housing is configured to conform to the camera and position sensor/rotatable ring sections.
